(19) United States
(12) Patent Application Publication
(10) Pub. No.: US 2016/0277856 A1
(43) Pub. Date: Sep. 22, 2016

(54) EARDRUM IMPLANTABLE HEARING AID

(71) Applicants: KUANG-CHAO CHEN, New Taipei (TW); SILICON MOTION, INC., Jhubei (TW)

(72) Inventors: KUANG-CHAO CHEN, New Taipei (TW); KUO-LIANG YEH, Hsinchu (TW)

(21) Appl. No.: 15/049,144

(22) Filed: Feb. 22, 2016

(30) Foreign Application Priority Data
Mar. 19, 2015 (TW) 104108820

(51) Int. Cl. H04R 25/00; G06F 17/28

(52) U.S. Cl. CPC H04R 25/554; G06F 17/289; H04R 25/606; H04R 25/353; H04R 2225/55

(57) ABSTRACT

An eardrum implantable hearing aid for assisting hearing of a user is provided. The eardrum implantable hearing aid includes an eardrum implantable speaker and a driving circuit. The eardrum implantable speaker is installed at a hole on an eardrum of the user. The driving circuit is connected to the eardrum implantable speaker and configured to process sound data and generate driving signals corresponding to the sound data. The driving signals drive the eardrum implantable speaker to generate air vibrations corresponding to the sound data in a direction from the eardrum toward a cochlea of the user, so as to assist the user to hear sounds corresponding to the sound data.

### FIELD OF THE INVENTION

The present invention relates to a hearing aid, and more particularly to a hearing aid implantable on an eardrum.

### BACKGROUND OF THE INVENTION

A large population of people in the world is born with hearing loss. For a child born without hearing, he or she may never be able to speak. Therefore, providing auditory reconstruction to people with hearing loss is highly meaningful.

### SUMMARY OF THE INVENTION

The present invention provides an eardrum implantable hearing aid for assisting hearing of a user. The eardrum implantable hearing aid includes an eardrum implantable speaker and a driving circuit. The eardrum implantable speaker is installed at a hole on an eardrum of the user. The driving circuit is connected to the eardrum implantable speaker and configured to process sound data and generate driving signals corresponding to the sound data. The driving signals drive the eardrum implantable speaker to generate air vibrations corresponding to the sound data in a direction from the eardrum toward a cochlea of the user, so as to assist the user to hear sounds corresponding to the sound data.

In one embodiment, the eardrum implantable speaker has a housing. The housing has a contacting portion abutting a portion of the eardrum corresponding to the hole, thereby supporting the eardrum implantable speaker to maintain at a specific position.

In one embodiment, the eardrum implantable hearing aid further includes a digital processing circuit configured to generate and adjust the sound data.

In one embodiment, the eardrum implantable hearing aid further includes a sound collector and a sound amplifier. The sound collector is configured to collect external sounds. The sound amplifier is configured to amplify the collected external sounds so as to generate the sound data.

In one embodiment, the sound amplifier and the driving circuit are connected through a wire.

In one embodiment, the sound amplifier and the driving circuit are connected via a wireless protocol.

In one embodiment, the eardrum implantable hearing aid further includes an eardrum wireless circuit configured to receive wireless signals and convert the wireless signals into the sound data.

In one embodiment, the wireless signals are provided by a handheld electronic device.

In one embodiment, the handheld electronic device is a mobile phone.

In one embodiment, the eardrum implantable hearing aid further includes a processing circuit mounted on a pair of eyeglasses and configured to generate the sound data for the driving circuit.

In one embodiment, the wireless signals include a control signal for adjusting output parameters of the eardrum implantable speaker.

In one embodiment, the eardrum implantable hearing aid further includes an eardrum power supply circuit configured to provide an electrical power to the eardrum implantable speaker and the driving circuit.

In one embodiment, the eardrum power supply circuit is wirelessly charged.

In one embodiment, two eardrums of the user are installed with a pair of the eardrum implantable hearing aids. The pair of the eardrum implantable hearing aids are each configured to adjust the output parameters of the respective eardrum implantable speaker.

In one embodiment, the eardrum implantable speakers of the pair of the eardrum implantable hearing aids provide different location-sensing sound signals to the two eardrums, thereby enabling the user to hear the sounds.

In one embodiment, the sound data is subjected to a translation process for converting unprocessed external sound signals into corresponding sound data with processed contents.

In one embodiment, the sound data are generated by capturing a portion of the unprocessed external sound signals and are played repeatedly.

In one embodiment, the sound data are one or more keywords in the unprocessed external sound signals and are played repeatedly.

In one embodiment, the translation process is a translation of a foreign language.

In one embodiment, the translation process is a conversion of a dialect.

### BRIEF DESCRIPTION OF THE DRAWINGS

Other advantages, objectives and features of the present invention will become apparent from the following description referring to the attached drawings.

FIG. 1 is a schematic diagram illustrating an eardrum implantable hearing aid installed in an inner ear of a user for assisting hearing in accordance with an embodiment of the present invention;

FIG. 2 is a schematic diagram illustrating a process of installing an eardrum implantable speaker at a hole on an eardrum in accordance with an embodiment of the present invention;

FIG. 3 is a schematic diagram illustrating the position of an eardrum implantable speaker with respective to an eardrum in accordance with an embodiment of the present invention;

FIG. 4 is a schematic diagram of the configuration of an eardrum implantable hearing aid in accordance with an embodiment of the present invention;

FIG. 5 is a schematic diagram illustrating the installation of an eardrum implantable hearing aid in accordance with another embodiment of the present invention;

FIG. 6 is a schematic diagram illustrating the installation of an eardrum implantable hearing aid in accordance with still another embodiment of the present invention;

FIG. 7 is a schematic diagram illustrating the installation of an eardrum implantable hearing aid with external devices in accordance with yet another embodiment of the present invention; and

FIG. 8 is a schematic diagram of an exemplary installation of a portion of an eardrum implantable hearing aid on a pair of smart glasses or conventional eyeglasses in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

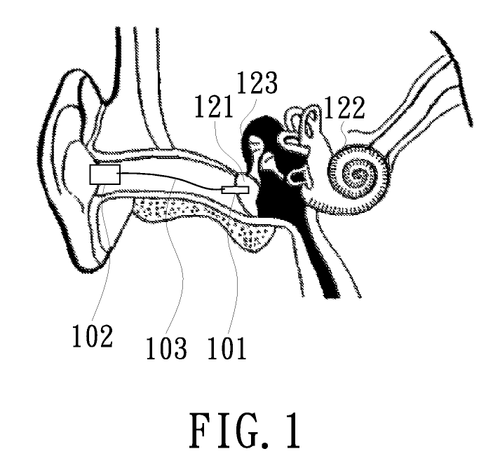

FIG. 1 is a schematic diagram illustrating an eardrum implantable hearing aid installed in the inner ear of a user for assisting hearing in accordance with an embodiment of the present invention. As shown in FIG. 1, the eardrum implantable hearing aid of the present embodiment includes an eardrum implantable speaker 101 and a driving circuit 102. The eardrum implantable speaker 101 is installed on a hole of an eardrum 121 of the user. The driving circuit 102 is connected to the eardrum implantable speaker 101 and configured to process sound data and generate corresponding driving signals. The driving signals are used to drive the eardrum implantable speaker 101 to generate air vibrations corresponding to the sound data in a direction toward the hearing organs, including the cochlea 122 and ossicle 123, to assist the user to hear sounds corresponding to the sound data.

The eardrum implantable speaker 101 may be designed based on different air vibration generation principles, such as pulling various materials through electromagnetic induction or clutching the surrounding air to generate acoustic waves. In one embodiment, the eardrum implantable speaker 101 may be comprised of electromagnets, coils and speaker diaphragms to convert current frequencies into sounds. Additionally, according to the principles of physics, it is to be understood that the direction of electromagnetic field generated by electrical currents flowing through the coil follows the right-hand rule. In one embodiment, the eardrum implantable speaker 101 is configured to play a C tune with a frequency of 256 Hz (namely, 256 vibrations per second) and output an AC of 256 Hz (namely, 256 current changes per second). In summary, the coil vibrates with the speaker diaphragm, causing the surrounding air to vibrate and thus the eardrum implantable speaker 101 to generate sounds.

As the eardrum implantable speaker 101 is hanged on and installed at the hole on the eardrum 121 and is therefore very close to the cochlea 122 and the ossicle 123, the eardrum implantable speaker 101 can achieve a significant sound effect by utilizing a small amount of power. Thus, as compared with conventional hearing aids in which signals are attenuated after transmission through the ear canal, the eardrum implantable hearing aid of the present invention requires low power and produces improved sound effect by directly hanging on and installing at the hole on the eardrum 121.

In one embodiment, the eardrum implantable speaker 101 of the present invention may include a housing, which has a contacting portion abutting a portion of the eardrum 121 corresponding to the hole. Thus, the eardrum implantable speaker 101 is supported and maintained at a specific position.

Design of the driving circuit 102 may vary. In one embodiment, the driving circuit 102 may be designed to include a variety of digital signal processing circuits. In another embodiment, the driving circuit 102 may be designed to include a digital analog converter circuit (DAC) only for current and voltage signal processing.

Besides the driving circuit 102 and the eardrum implantable speaker 101, the eardrum implantable hearing aid may further include a digital processing circuit configured to generate and adjust the sound data. In one embodiment, the digital processing circuit may perform noise reduction, sound waveform adjustment or echo cancellation on external sounds. In another embodiment, the digital processing circuit can be implemented into a corresponding integrated circuit chip.

In one embodiment, the eardrum implantable hearing aid of the present invention may further include a sound collector and a sound amplifier. The sound collector, such as a microphone, is configured to collect external sounds. The sound amplifier is configured to amplify the external sounds to generate the sound data.

As mentioned above, since the eardrum implantable speaker 101 is installed at the inner ear, the eardrum implantable speaker 101 may not be suitable for collecting external sounds. Thus, the sound collector (e.g. a microphone) may be disposed on or close to the outer ear, and transmit sound data to the eardrum implantable speaker 101 through a wire 103 or wirelessly.

Additionally, with the improvement of electronic miniaturization techniques, the circuits may be made into strips and directly disposed on the ear canal. Thus, wearers of the eardrum implantable hearing aid of the present invention have less psychological rejection and higher mobility.

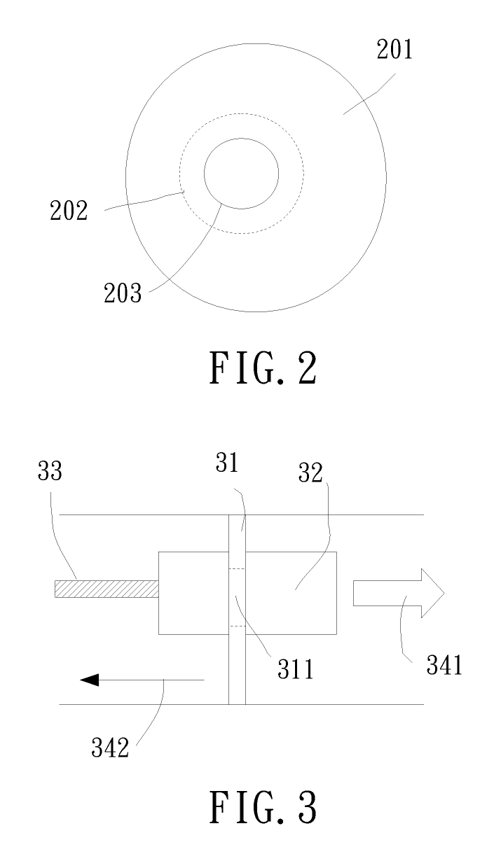

Please refer to FIG. 2, which illustrates a process of installing an eardrum implantable speaker at a hole on an eardrum in accordance with an embodiment of the present invention. As shown in FIG. 2, a physician performs a surgery to generate a small hole 202 on the eardrum 201 and then hangs the eardrum implantable speaker onto the hole 202. Once the hole 202 is healed therefore forming a hole 203 closely contacted with the eardrum implantable speaker, the eardrum implantable speaker is appropriately maintained at a specific position.

FIG. 3 is a schematic diagram illustrating the position of an eardrum implantable speaker 32 with respective to an eardrum 31 in accordance with an embodiment of the present invention. As shown in FIG. 3, the eardrum 31 has a hole 311 opened by a physician for supporting the eardrum implantable speaker 32. The eardrum implantable speaker 32 is configured to generate sound vibrations in a direction 341 toward the cochlea and the ossicle, therefore proving the user the information to hear.

Additionally, to alleviate the burden of the eardrum 31 to carry the eardrum implantable speaker 32, some components of the eardrum implantable speaker 32 may be disposed on the ear canal and connected to the eardrum implantable speaker 32 through a wire 33. By disposing some components of the eardrum implantable speaker 32 in a direction 342 toward the outer ear, external sounds can be collected more effectively.

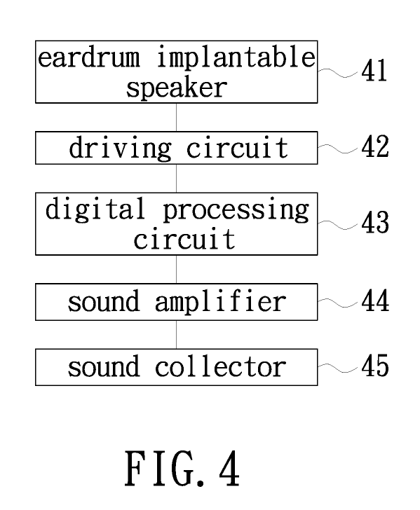

Please refer to FIG. 4, which illustrates the configuration of an eardrum implantable hearing aid in accordance with an embodiment of the present invention. As shown in FIG. 4, the eardrum implantable hearing aid in the present embodiment includes an eardrum implantable speaker 41, a driving circuit 42, a digital processing circuit 43, a sound amplifier 44 and a sound collector 45. The driving circuit 42 is electrically connected to the eardrum implantable speaker 41; the digital processing circuit 43 is electrically connected to the driving circuit 42; the sound amplifier 44 is electrically connected to the digital processing circuit 43; and the sound collector 45 is electrically connected to the sound amplifier 44. The sound collector 45 is adopted for collecting external sounds. The sound amplifier 44 is adopted for amplifying the external sounds collected by the sound collector 45. The digital processing circuit 43 is configured for receiving the external sounds amplified by the sound amplifier 44 and generating and adjusting the sound data. In one embodiment, the digital processing circuit 43 may perform noise reduction, sound waveform adjustment or echo cancellation on the external sounds. The driving circuit 42 is configured for processing the sound data and generating a corresponding driving signal. The eardrum implantable speaker 41 is configured for generating sound vibrations corresponding to the sound data in a direction toward the cochlea and the ossicle, therefore enabling the user to hear sounds corresponding to the sound data. In one embodiment, the aforementioned components or devices may be disposed in a housing. In another embodiment, the aforementioned components or devices may be disposed separately and are electrically connected with one another through wires or wireless means.

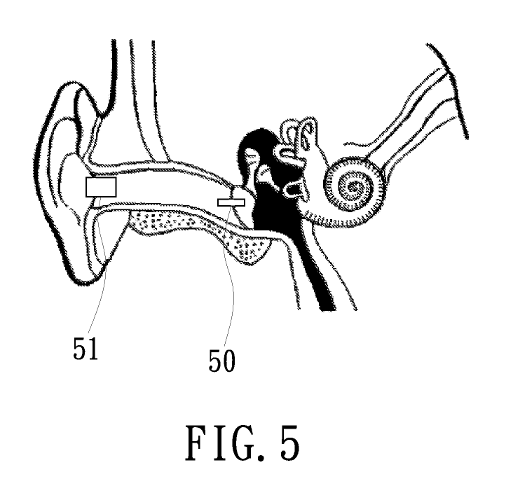

FIG. 5 is a diagram schematically illustrating the installation of an eardrum implantable hearing aid in accordance with another embodiment of the present invention. As shown in FIG. 5, the eardrum implantable hearing aid in the present embodiment includes an inner ear portion 50 and an outer ear portion 51. The inner ear portion 50 includes an eardrum implantable speaker and the associated circuits, such a power supply, directly hanging on a hole on an eardrum. The outer ear portion 51 is configured to transmit the collected signals to the inner ear portion 50 wirelessly. Thus, in one embodiment, the outer ear portion 51 may be further configured to electrically charge the inner ear portion 50 wirelessly. In another embodiment, the outer ear portion 51 is configured to generate an electromagnetic signal. The electromagnetic signal is transmitted to the corresponding sensors (e.g., coils) in the inner ear portion 50, therefore generating acoustic waves accordingly. As the eardrum implantable speaker is installed close to the cochlea and the ossicle, the eardrum implantable hearing aid of the present invention can provide signals with sufficient intensity without requiring a large amount of power supply. In addition, via electromagnetic induction, the inner ear portion 50 may also function without having to install a battery thereon.

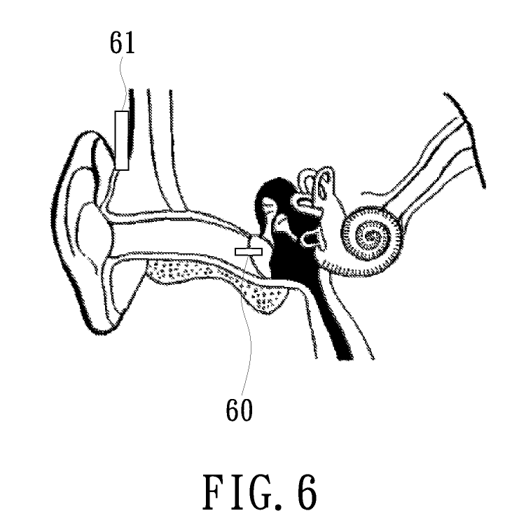

FIG. 6 is a diagram schematically illustrating the installation of an eardrum implantable hearing aid in accordance with still another embodiment of the present invention. As shown in FIG. 6, the eardrum implantable hearing aid in the present embodiment includes an inner ear portion 60 and an outer ear portion 61. The outer ear portion 61 is hanged on top of an ear, instead of plugging the opening of the ear canal. In addition, the outer ear portion 61 is configured to transmit the collected signals to the inner ear portion 60 through a wire or wirelessly.

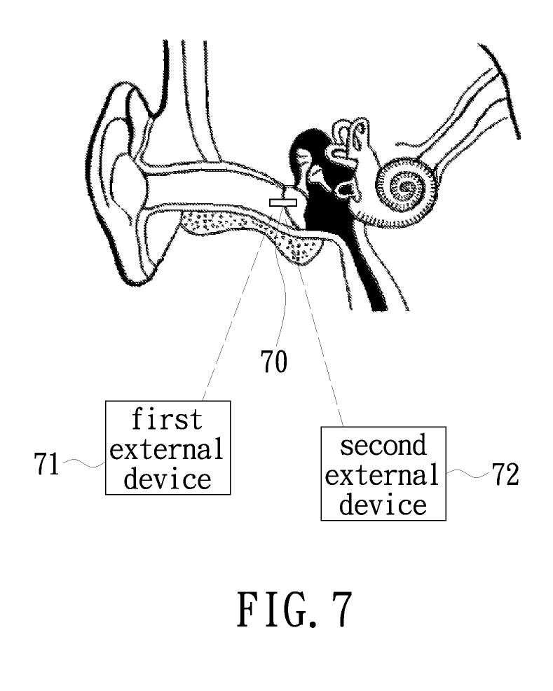

FIG. 7 is a diagram schematically illustrating the installation of an eardrum implantable hearing aid in accordance with yet another embodiment of the present invention. As shown in FIG. 7, the eardrum implantable hearing aid in the present embodiment includes an inner ear portion 70 and at least one external device. In the present embodiment, the eardrum implantable hearing aid is exemplified by having a first external device 71 and a second external device 72. In one embodiment, the first external device 71 and/or the second external device 72 are configured to transmit signals to the inner ear portion 70 directly. In another embodiment, the first external device 71 and/or the second external device 72 are configured to electrically charge the inner ear portion 70. In one embodiment, the first external device 71 may be an electronic device directly provided by the manufacturer of the eardrum implantable hearing aid, and the second external device 72 may be a device owned by the user, such as a mobile phone, a television, or other signal source. In other words, the inner ear portion 70 may be coupled to one or more signal sources and convert the one or more signal sources into sound signals. In one embodiment, weights of the signal sources may be adjusted in response to the user's needs.

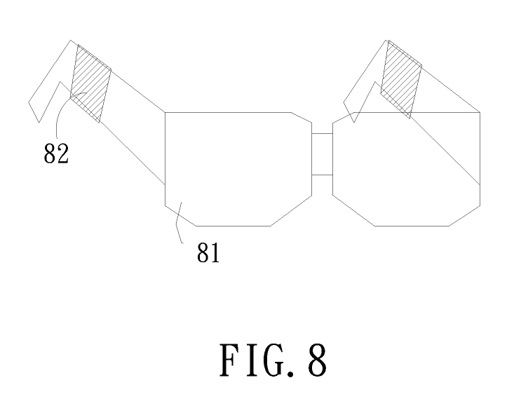

Please refer to FIG. 8, which illustrates an exemplary installation of a portion of an eardrum implantable hearing aid on a pair of smart glasses or conventional eyeglasses in accordance with an embodiment of the present invention. As shown in FIG. 8, the outer ear portion 82 of an eardrum implantable hearing aid is mounted on a pair of eye glasses 81; wherein the eyeglasses 81 may be a pair of typical glasses or a pair of smart glasses, and the present invention is not limited thereto.

In the eardrum implantable hearing aid of the present invention, if signal transmission from the outer ear portion (or the external device) to the inner ear portion is conducted wirelessly, a variety of publicly recognized communication protocols, such as Bluetooth, wireless USB, ZigBee, Wi-Fi may be utilized. In one embodiment, the signal transmission from the outer ear portion (or the external device) to the inner ear portion may be conducted based on a communication protocol specifically-defined for the eardrum implantable hearing aid.

In one embodiment, the eardrum implantable hearing aid of the present invention may further include an eardrum wireless circuit configured to receive wireless signals and convert the wireless signals into the sound data. In one embodiment, the wireless signals are provided by a mobile phone or other types of handheld electronic device.

In one embodiment, the eardrum implantable hearing aid of the present invention may further include a processing circuit mounted on a pair of regular eyeglasses or a pair of smart glasses and configured to generate the sound data for the driving circuit of the eardrum implantable hearing aid.

In one embodiment, the eardrum implantable hearing aid of the present invention may include a variety of operating modes, which are designed to operate under different sets of parameters and algorithms for sound processing. For example, if the eardrum implantable hearing aid is electrically connected to a mobile phone, some of the operations can be outsourced to the mobile phone, and circuits of the eardrum implantable hearing aid only provide basic functions such as outputting sounds, therefore reducing power consumption of the eardrum implantable hearing aid. Additionally, the sound data may be subjected to more complicated processing by utilizing external handheld devices, therefore expanding more auxiliary features on the eardrum implantable hearing aid of the present invention.

In one embodiment, wireless signals transmitted to the eardrum implantable speaker may include a control signal for adjusting the output parameters of the eardrum implantable speaker. For example, the control signal may adjust the output power of a pair of the eardrum implantable speakers installed on both ears of the user, therefore avoiding the discomfort caused by sound differences between the two ears.

In one embodiment, the eardrum implantable hearing aid of the present invention may further include an eardrum power supply circuit configured to provide electrical power to the eardrum implantable speaker and the driving circuit. Additionally, with the improvement of the wireless charging technology, a variety of wireless charging techniques may be integrated into the eardrum implantable hearing aid of the present invention, therefore providing an eardrum implantable hearing aid with higher life convenience.

It is to be understood that hearing also provides human a sense of direction. Thus, sound processing of an eardrum implantable hearing aid in one embodiment may further include providing location-sensing sound signals. For example, in one embodiment, the eardrum implantable hearing aid includes a plurality of microphones disposed at different locations for collecting external sounds. As the time at which each of the microphones collecting external sounds is distinct, the human brain would analyze the time difference and be able to identify the positions of the corresponding objects (e.g., vehicles or footsteps); therefore, responding to the external sounds properly.

As the location-sensing sound signals may also affect the sense of balance, different parameter settings and adjustments may be provided according to the hearing conditions of the two ears of the user, therefore providing a more comfortable hearing aid wearing experience. Considering the parameter settings and adjustments may vary by the environmental conditions and longer adjustment time, multiple sets of parameters may be stored in a mobile phone or other handheld electronic device of the user for the user to adjust the output parameters according to their needs. For example, the handheld electronic device may store parameters for environmental conditions such as watching TV, during classes, conversing with others, and self-talking to learn a language; in this way, the most suitable sound outputs and the corresponding parameters are provided by the user simply indicating the environmental condition. In one embodiment, the environmental conditions can be automatically determined based on GPS or Wi-Fi signals or time information.

As the sound data are processed signals in the present invention, it is to be noted that the sound data is not necessarily consistent with the original sound signals. In other words, the sound data may be subjected to a translation process for converting unprocessed external sound signals into corresponding sound data with processed contents.

For example, the sound data may be generated by capturing a portion of the unprocessed external sound signals and played repeatedly. Specifically, in one embodiment, the original sound signals are analyzed to identify the keywords contained therein, and only the keywords are outputted. Thus, by repeatedly playing the keywords, elderly wearing the eardrum implantable hearing aid of the present invention may quickly catch and understand the information delivered in the original sound signals. In another embodiment, the eardrum implantable hearing aid of the present invention may record the external sounds, and the user can select to hear the contents of the recorded external sounds repeatedly. It is to be noted that the external sounds described herein is referred to as sounds directly produced by an actual object, sound signals generated by an electronic device (e.g., an alarm sound generated by an alarm clock), or signals of a translated language.

In one embodiment, the eardrum implantable hearing aid of the present invention can convert an official language into a dialect. Thus, if a grandfather only understands a dialect but his grandson only speaks an official language, the grandfather and the grandson may communicate with each other when the grandfather wears the eardrum implantable hearing aid of the present invention with dialect conversion and sound recording for repeated playing functions. Consequently, the eardrum implantable hearing aid of the present invention has a positive impact on the life quality of human beings.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An eardrum implantable hearing aid for assisting hearing of a user, the eardrum implantable hearing aid comprising:
an eardrum implantable speaker, installed at a hole on an eardrum of the user; and
a driving circuit, connected to the eardrum implantable speaker and configured to process sound data and generate driving signals corresponding to the sound data,
wherein the driving signals drive the eardrum implantable speaker to generate air vibrations corresponding to the sound data in a direction from the eardrum toward a cochlea of the user, so as to assist the user to hear sounds corresponding to the sound data.

2. The eardrum implantable hearing aid according to claim 1, wherein the eardrum implantable speaker comprises a housing, the housing comprises a contacting portion abutting a portion of the eardrum corresponding to the hole, thereby supporting the eardrum implantable speaker to maintain at a specific position.

3. The eardrum implantable hearing aid according to claim 1, further comprising a digital processing circuit, configured to generate and adjust the sound data.

4. The eardrum implantable hearing aid according to claim 1, further comprising:
a sound collector, configured to collect external sounds; and
a sound amplifier, configured to amplify the collected external sounds so as to generate the sound data.

5. The eardrum implantable hearing aid according to claim 4, wherein the sound amplifier and the driving circuit are connected through a wire.

6. The eardrum implantable hearing aid according to claim 4, wherein the sound amplifier and the driving circuit and connected via a wireless protocol.

7. The eardrum implantable hearing aid according to claim 1, further comprising an eardrum wireless circuit, configured to receive wireless signals and convert the wireless signals into the sound data.

8. The eardrum implantable hearing aid according to claim 7, wherein the wireless signals are provided by a handheld electronic device.

9. The eardrum implantable hearing aid according to claim 8, wherein the handheld electronic device is a mobile phone.

10. The eardrum implantable hearing aid according to claim 7, further comprising a processing circuit, mounted on a pair of eyeglasses and configured to generate the sound data for the driving circuit.

11. The eardrum implantable hearing aid according to claim 7, wherein the wireless signals comprise a control signal for adjusting output parameters of the eardrum implantable speaker.

12. The eardrum implantable hearing aid according to claim 1, further comprising an eardrum power supply circuit, configured to provide an electrical power to the eardrum implantable speaker and the driving circuit.

13. The eardrum implantable hearing aid according to claim 12, wherein the eardrum power supply circuit is wirelessly charged.

14. The eardrum implantable hearing aid according to claim 1, wherein two eardrums of the user are installed with a pair of the eardrum implantable hearing aids, and the pair of the eardrum implantable hearing aids are each configured to adjust output parameters of the respective eardrum implantable speaker.

15. The eardrum implantable hearing aid according to claim 14, wherein the eardrum implantable speakers of the pair of the eardrum implantable hearing aids provide different location-sensing sound signals to the two eardrums, thereby enabling the user to hear the sounds.

16. The eardrum implantable hearing aid according to claim 1, wherein the sound data is subjected to a translation process for converting unprocessed external sound signals into corresponding sound data with processed contents.

17. The eardrum implantable hearing aid according to claim 16, wherein the sound data are generated by capturing a portion of the unprocessed external sound signals and are played repeatedly.

18. The eardrum implantable hearing aid according to claim 16, wherein the sound data are one or more keywords in the unprocessed external sound signals and are played repeatedly.

19. The eardrum implantable hearing aid according to claim 16, wherein the translation process is a translation of a foreign language.

20. The eardrum implantable hearing aid according to claim 16, wherein the translation process is a conversion of a dialect.
